(19) United States
(12) Patent Application Publication
(10) Pub. No.: US 2006/0027659 A1
(43) Pub. Date: Feb. 9, 2006

(54) Integrated exit window and imaging engine

(75) Inventors: Mehul Patel, Fort Salonga, NY (US); Tsi David Shi, Stony Brook, NY (US)

Correspondence Address: Carter, DeLuca, Farrell & Schmidt, LLP, Suite 225, 445 Broad Hollow Road, Melville, NY, 11747, US

(73) Assignee: Symbol Technologies, Inc.

(21) Appl. No.: 11/224,828

(22) Filed: Sep. 12, 2005

Related U.S. Application Data
(63) Continuation-in-part of application No. 10/633,061, filed on Aug. 1, 2003.

(51) Int. Cl. G06K 7/10

(52) U.S. Cl. 235/454; 235/462.41

(57) ABSTRACT

An integrated exit window lens array and imaging and illuminating engine for an optical code reader to illuminate and image remote target indicia, such as an optical code, is provided. The integrated exit window lens array and engine includes an image sensor for receiving reflected illumination from the remote indicia and an illumination assembly illuminating the remote indicia. The illumination assembly is capable of providing a plurality of different outputs, such as light having different wavelengths. The illumination assembly can also be provided with a single illuminating device for providing one illumination output for illuminating substantially the entire field of view. A transmissive, optical element overlays the engine for preventing light generated by the illumination assembly from reflecting back towards the image sensor. The integrated exit window lens array and imaging engine is an integrated circuit package configured for easily interfacing within an optical code reader as a plug-and-play component.

This application is a continuation-in-part (CIP) of U.S. patent application Ser. No. 10/633,061 filed on Aug. 1, 2003 entitled “IMAGING AND ILLUMINATION ENGINE FOR AN OPTICAL CODE READER,” the entire contents of which is incorporated by reference herein.

### BACKGROUND

1. Field

This disclosure relates to imaging in optical code reading devices. Aspects of the disclosure are particularly useful in solid-state optical code readers for illuminating and imaging remote target indicia, such as an optical code. The present disclosure is useful in CCD based bar code readers, and other imaging devices.

2. Description of the Related Art

Optical codes are patterns made up of image areas having different light reflective or light emissive properties, which are typically assembled in accordance with a priori rules. The term “barcode” is sometimes used to describe certain kinds of optical codes. The optical properties and patterns of optical codes are selected to distinguish them in appearance from the background environments in which they are used. Devices for identifying or extracting data from optical codes are sometimes referred to as “optical code readers” of which barcode scanners are one type. Optical code readers are used in fixed or portable installations in many diverse environments such as in stores for checkout services, in manufacturing locations for workflow and inventory control and in transport vehicles for tracking package handling. The optical code can be used as a rapid, generalized means of data entry, for example, by reading a target barcode from a printed listing of many barcodes. In some uses, the optical code reader is connected to a portable data processing device or a data collection and transmission device. Frequently, the optical code reader includes a handheld sensor that is manually directed at a target code.

Most conventional optical scanning systems are designed to read one-dimensional barcode symbols. The barcode is a pattern of variable-width rectangular bars separated by fixed or variable width spaces. The bars and spaces have different light reflecting characteristics. One example of a one-dimensional barcode is the UPC/EAN code used to identify, for example, product inventory. An example of a two-dimensional or stacked barcode is the PDF417 barcode. A description of PDF417 barcode and techniques for decoding it are disclosed in U.S. Pat. No. 5,635,697 to Shellhammer et al., and assigned to Symbol Technologies, Inc., which is incorporated herein by reference. Another conventional optical code is known as “MaxiCode.” It consists of a central finder pattern or bull's eye center and a grid of hexagons surrounding the central finder. It should be noted that the aspects of the embodiments disclosed in this patent application are applicable to optical code readers, in general, without regard to the particular type of optical codes, which they are adapted to read. The embodiments described may also be applicable to some associated image recognition or analysis.

Most conventional laser scanning systems generate one or more beams of laser light, which reflects off a barcode symbol, and back to the scanning system. The system obtains a continuous analog waveform corresponding to the light reflected by the code along one or more scan lines of the system. The system then decodes the waveform to extract information from the barcode. A system of this general type is disclosed, for example, in U.S. Pat. No. 4,251,798, assigned to Symbol Technologies, Inc. A beam scanning system for detecting and decoding one and two-dimensional barcodes is disclosed in U.S. Pat. No. 5,561,283 also assigned to Symbol Technologies, Inc.

Typically, a laser beam generated by a laser source, for example, a gas laser tube or a semiconductor laser diode, is optically focused by an optical train into a generally circular laser beam spot on a symbol. The beam spot is swept by a scanning component over the symbol and forms a scan pattern thereon. Laser light reflected off the symbol is detected by a light sensor, e.g. a photodiode, mounted together with the laser source, the optical train, the scanning component, and the photodiode in a housing, preferably one having a handle to enable hand-held, portable operation.

The symbol itself is a coded pattern comprised of a series of bars of various widths, the bars being spaced apart from one another to bound spaces of various widths, the bars and spaces having different light-reflective properties. Although dimensions may vary, depending on the particular application and the density of the symbol, each bar and space of a UPC symbol typically used in the retail industry to identify retail products measures on the order of thousandths of an inch (mils). In practice, the generally circular laser beam spot has a cross-sectional diameter on the order of 6 to 10 mils.

Barcodes can also be read by employing imaging systems having an image sensor and a plurality of illuminating devices for illuminating the field of view. The image sensor generally includes a two-dimensional array of cells or photo sensors which correspond to image elements or pixels in the field of view. The image sensor may be a two-dimensional or area charge coupled device (CCD) and associated circuits for producing electronic signals corresponding to a two-dimensional array of pixel information for a field of view.

Laser scanning and imaging systems generally include a handheld unit that is manually ointed at the target during a scanning or imaging procedure. The handheld unit is often a omponent of a much larger system including other scanners, computers, cabling, data terminals, etc. Such systems are frequently designed and constructed based on mechanical and optical specifications for the scanning or imaging engine, sometimes called “form factors.” One such form factor is the SE900 form factor utilized by Symbol Technologies, Inc.

Accordingly, there is a need to provide a compact imaging engine that can be substituted for conventional laser line scanning engines in currently designed and currently deployed optical code reader systems.

There is another need to provide an imaging engine that can be substituted for predetermined form factor scanning engines, such as the SE900 form factor scanning engine, in currently designed and currently deployed optical code reading systems to increase the reliability, versatility, and target working range of such systems.

Furthermore, an exit window is located in front of the internal illumination devices (usually light emitting diodes (LEDs) or laser diodes) of the imaging engine. The light generated by the internal illumination devices reflects from the exit window and creates bright spots in the image. The bright spots reduce the performance of the scanning system because the spots typically cause a no-read during decoding. Thus, there is a need to prevent reflections from the exit window.

### SUMMARY

The present disclosure relates to an integrated exit window lens array and imaging engine. The integrated exit window lens array and imaging engine includes an imaging engine configured and dimensioned to fit within a predetermined form factor of an optical code reader having a housing and circuitry therein. The imaging engine includes: at least one image sensor; at least one illumination assembly having at least one illuminating device, with the at least one image sensor and the at least one illuminating device being provided on a substrate. The imaging engine also includes an interface having at least one signal path configured for providing at least one control signal to the at least one image sensor. The at least one control signal is generated and transmitted to the interface of said imaging engine by said circuitry housed within said housing for operating said at least one image sensor and said at least one illumination assembly. Furthermore, the imaging engine includes an exit window lens array having at least one orifice and at least one transmissive optic surface disposed thereupon; and an integrating member for integrating the exit window lens array with the substrate. The exit window lens array is configured for substantially aligning the at least one orifice with the at least one image sensor when the exit window lens array is integrated with the substrate such that an inner surface of the exit window lens array at least partially opposes an outer surface of the substrate.

The present disclosure relates also to an optical code reader having a housing and circuitry therein, with the optical code reader including an integrated exit window lens array and imaging engine. The optical code reader includes an imaging engine configured and dimensioned to fit within a predetermined form factor of the optical code reader. The imaging engine includes: at least one image sensor; at least one illumination assembly having at least one illuminating device, with the at least one image sensor and the at least one illuminating device being provided on a substrate. The imaging engine also includes an interface having at least one signal path configured for providing at least one control signal to the at least one image sensor.

The at least one control signal is generated and transmitted to the interface of said imaging engine by said circuitry housed within said housing for operating said at least one image sensor and said at least one illumination assembly. Furthermore, the imaging engine includes an exit window lens array having at least one orifice and at least one transmissive optic surface disposed thereupon; and an integrating member for integrating the exit window lens array with the substrate. The exit window lens array is configured for substantially aligning the at least one orifice with the at least one image sensor when the exit window lens array is integrated with the substrate such that an inner surface of the exit window lens array at least partially opposes an outer surface of the substrate.

### BRIEF DESCRIPTION OF THE DRAWINGS

FIG. 1 is a perspective view of the imaging engine in accordance with one embodiment of the present disclosure;

FIG. 2 is a side view of the imaging engine of FIG. 1;

FIG. 3 is a perspective view of the imaging engine of FIG. 1 according to another embodiment of the present disclosure;

FIG. 4 is a perspective view of the imaging engine of FIG. 1 according to yet another embodiment of the present disclosure;

FIG. 5 is a perspective view of the imaging engine of FIG. 1 according to still another embodiment of the present disclosure;

FIG. 6 is block diagram of an imaging system according to the present disclosure;

FIG. 7 is a side view of an optical code reading system according to an embodiment of the present disclosure;

FIG. 8 is a side view of a prior art illumination assembly;

FIG. 9 is a perspective view of an integrated exit window lens array and imaging engine according to one embodiment of the present disclosure;

FIG. 10 is a side view of the integrated exit window lens array and imaging engine of FIG. 9;

FIG. 11 is a perspective view of an alternate embodiment of the exit window lens array of the present disclosure;

FIG. 12A is a perspective view of another alternate embodiment of the exit window lens array of the present disclosure; and

FIG. 12B is a side view of a portion of an optic surface of the exit window lens array of FIG. 12A.

### DETAILED DESCRIPTION

The present disclosure will be understood more fully from the detailed description given below and from the accompanying drawings of particular embodiments of the present disclosure which, however, should not be taken to limit the present disclosure to a specific embodiment but are for explanatory purposes. More particularly, numerous specific details may be set forth herein to provide a thorough understanding of a number of possible embodiments of an integrated exit window lens array and imaging engine incorporating the present disclosure. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments disclosed herein are not necessarily limited in this context.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Several embodiments of the present disclosure are hereby disclosed in the accompanying description in conjunction with the figures. Advantageously, each of the embodiments of the integrated exit window lens array and imaging engine is adapted to substitute for a predetermined form factor scanning engine, such as the SE900 form factor scanning engine used in many commercially available optical code readers.

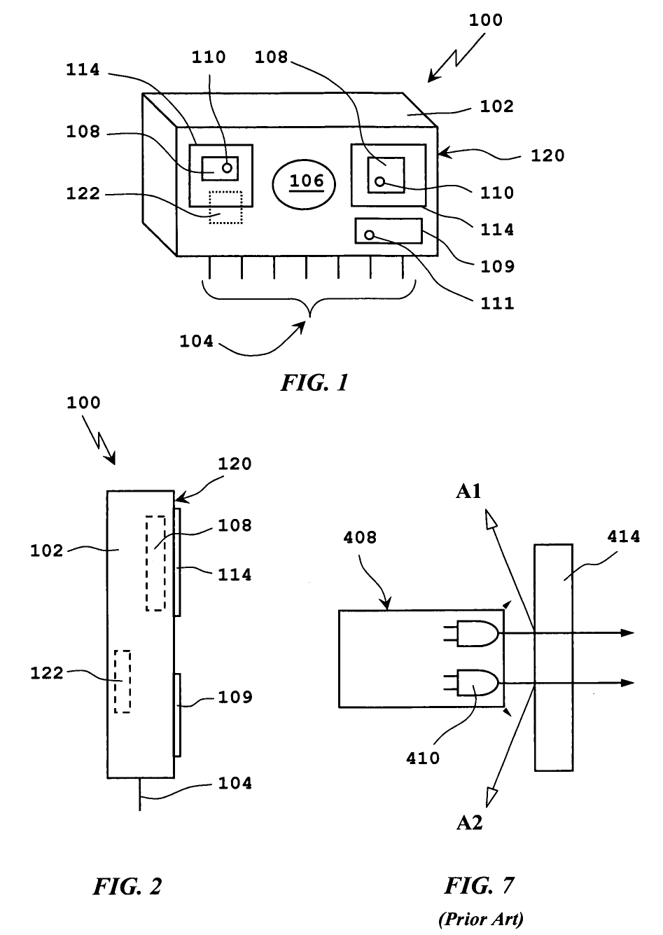

Exemplary embodiments of the present disclosure will now be described in detail with reference to the figures wherein like reference numerals identify similar or identical elements. In a first embodiment as illustrated in FIGS. 1 and 2, the imaging engine of the present disclosure is generally designated as 100. As used herein, the term “distal” refers to that portion that is further from the user while the term “proximal” refers to that portion that is closer to the user.

As shown in FIGS. 1 and 2, the imaging engine 100 includes a substrate 120 that includes a base member 102 and additional components of the imaging engine 100. In a first embodiment, the substrate 120 is formed from suitable non-conductive material in a generally rectangular configuration. Although the substrate is shown as a three-dimensional rectangle, alternate three-dimensional configurations that adequately house the additional components of the imaging engine 100 are envisioned as well. A plurality of cavities is formed in the base member 102 for housing additional components that include an image sensor 106 and an illumination assembly 108. Internal to the base member 102 are a plurality of passages dimensioned and configured for accommodating conductive elements that connect the image sensor 106, the illumination assembly 108, an aiming or targeting assembly 109 and an interface assembly 122.

The interface assembly 122 transfers signals between the image sensor 106 and circuitry in an optical code reader, such as optical code reader 260 shown in FIG. 7, or other optical code readers known in the art. The interface assembly 122 also transfers signals between the optical code reader 260 and the illumination assembly 108, and the optical code reader 260 and the targeting assembly 109. In addition, the interface assembly 122 may include a microprocessor that processes received data, controls the output of each illumination assembly 108, coordinates the flow of signals amongst the various circuits, and communicates with circuitry 212 in the optical code reader 260.

More than one image sensor 106, as disclosed and described in a U.S. Provisional Application assigned Ser. No. 60/437,959, filed on Jan. 3, 2003, and more than one illumination assembly 108 may be included in the imaging engine 100 depending on the intended application of the imaging engine 100. The entire contents of U.S. Provisional Application assigned Ser. No. 60/437,959, filed on Jan. 3, 2003, are incorporated herein by reference.

Additionally, image sensors 106 of different types may be employed for increasing the versatility of the imaging engine 100. Each image sensor 106 is positioned on a face of the base member 102 and is aligned with an optical beam path of the optical code reader 260 for receiving reflected light from an external target, such as a barcode or other remote indicia. Advantageously, the imaging engine 100 is configured and dimensioned to fit a predetermined form factor, such as the SE900 form factor, and can be configured and dimensioned for use in other optical code readers including mobile devices as well as stationary devices.

In one embodiment, the substrate 120 includes the base member 102, wherein a plurality of depressions or recesses are formed to receive a corresponding number of image sensors 106 and illumination assemblies 108. Each depression includes at least one receptacle dimensioned to receive either an image sensor 106 or an illumination assembly 108. Using receptacles in the respective depressions allows modular components to be used with the imaging engine 100. Further still, since the components are modular, the imaging engine 100 is easily configurable for different applications, easily repairable by replacing a damaged component, or easily upgradeable as improvements are made in the underlying technologies.

Advantageously, the imaging engine of the present disclosure is an integrated circuit (IC) package where all the components are placed on the base member 102 and integrally formed as an integrated circuit package. Prior art imaging engines required the unit including the imaging engine to be returned to the factory or other service facility for servicing resulting in increased costs and reduced flexibility of the systems employing the prior art imaging engines. However, since the imaging engine of the present disclosure is a plug-and-play component, the imaging engine is easily installed or removed by the end-user personnel.

With reference to FIG. 7, where an optical code reading kit is shown, if a different imaging engine is required for a particular application, the end-user merely replaces the installed imaging engine with a different imaging engine suited for the particular application. As shown in FIG. 7, an optical code reading system 200 includes the optical code reader 260 that is configured and dimensioned to receive an imaging engine conforming to a predetermined form factor. An adapter 210 is preferably located within the optical code reader 260 and is dimensioned and configured to receive the imaging engine. Further still, the adapter 210 includes circuitry and/or signal paths for communication between the imaging engine and the optical code reader 260. Typically, the adapter 210 is a low-insertion force type of adapter to minimize damage to the leads of the imaging engine and to transfer data to the circuitry 212 provided on a logic board 214 of the optical code reader 260. Depending on the given application for the optical code reader 260, the installed imaging engine is selected from among various plug-and-play imaging engines 220, 230, 240, or 250 wherein each imaging engine is designed and adapted for reading optical targets under different conditions of lighting, distance, type of optical target, or other given optical criteria.

By way of example, if the installed imaging engine is designed and adapted for use in a system for reading remote indicia at a relatively short range and the user requires a system for reading remote indicia at a relatively long range, the user merely removes the installed imaging engine and installs a different imaging engine designed and adapted for longer ranges.

The installed imaging engine is readily removed or installed. If the installed imaging engine needs to be changed for either operational considerations, for repair, or for upgrade, the perator accesses the installed imaging engine through an access port (not shown) on the optical ode reader 260 after removing power or turning the optical code reader 260 off. Since the installed imaging engine is a plug-and-play component, the operator easily removes the installed imaging engine out of the adapter 210 without the use of excess force. Next, the operator selects an imaging engine from among the other imaging engines 220, 230, 240, or 250 that is to be installed. The selected imaging engine is inserted into the adapter 210 using a minimum amount of force since the adapter 210 is a low-insertion force type adapter. It should be noted that the imaging engines 220, 230, 240 or 250 are actually installed in the housing 218 of the optical code reader 260 “face forward” but are illustrated in FIG. 7 as “face sideways” for clarity.

After closing the access port, the operator then turns on, or applies power to the optical code reader 260. Now the optical code reader 260 is ready for use with the replacement imaging engine. Advantageously, each plug-and-play imaging engine is configured and dimensioned for removal and/or installation within the form factor without the need for anti-static precautions. Essentially, each plug-and-play imaging engine, the adapter 210, and the optical code reader 260 are resistant to electro-static discharges therefore, no special precautions such as grounding devices are required for removal and/or insertion of the imaging engine.

Alternately, the optical code reading system 200 illustrated in FIG. 7 may be configured as a kit wherein a number of plug-and-play imaging engines are included in the kit. Each included imaging engine is configured and adapted for a particular purpose wherein each imaging engine is particularly adapted for a given set of conditions. These conditions include the type of illumination used to illuminate the target indicia, the intensity of the illumination of the target indicia, the intensity of the background illumination of the target indicia, the distance between the target indicia and the imaging engine, and the type of target indicia that is to be read.

Advantageously, the kit includes predetermined form factor optical code reader 260 and at least one imaging engine, such as imaging engine 100, where each imaging engine further includes an illumination assembly. Each supplied imaging engine is configured and dimensioned to be received by the optical code reader 260, to communicate with the circuitry 212 in the optical code reader 260, and to read a different optical quality of the target code. Thusly, the kit is flexible for accommodating a variety of lighting conditions, target codes, and/or combinations thereof.

All of the receptacles on the base member 102 transfer signal data to and from the interface assembly 122 via a plurality of electrically conductive traces formed integrally with the base member 102. Typically, the depressions of the base member 102 are adapted and configured such that each of the image sensors 106, illumination assemblies 108, and targeting assembly 109 are disposed substantially at or just below the outer surface of the base member 102, as shown in FIG. 2. This provides for a top surface of these components to be substantially flush with the outer surface of the base member 102.

Advantageously, the substrate 120 will be disposed in a modular package having at least one signal interface system 104 for interfacing with the circuitry 212 of the optical code reader 260. A type of signal interface system 104 that may be employed includes a plurality of electrically conductive leads that interface with a correspondingly configured receptacle in the optical code reader 260. The signal interface systems 104 also serve the function of releasably attaching the modular package to the receptacle. Other types of signal interface systems 104 that may be employed include optically interface systems or wireless interface systems.

In instances where the signal interface systems 104 do not include an attachment means for the modular package, other conventional means of securing the modular package to the optical code reader 260 can be used.

Each illumination assembly 108 includes one or more, i.e., at least one, illuminating device 110 that is operatively coupled to the interface assembly 122 via one or more of the internal conductive elements. In its simplest form, the image sensor 106 includes one illuminating device 110 for illuminating the entire field of view. This is possible, as compared to prior art imaging engines, because the imaging engine 100 is fabricated and packaged as a modular, integrated circuit package.

According to the present disclosure, the illuminating device 110 can be either a coherent or an incoherent light source. Typically, an incoherent light source is an LED while a typical coherent light source is a laser. Different types of lasers may be employed as an illuminating device 110, such as semiconductor lasers (including LDs). Types of semiconductor lasers include edge-emitting injection lasers or typically, a vertical-cavity surface-emitting laser diode (VCSEL) as disclosed in U. S. Patent No. 6,024,283 to Campanelli et al. assigned to Symbol Technologies, Inc. and is hereby incorporated by reference. Hence, when a plurality of illuminating devices 110 is disposed in each illumination assembly 108, the illumination assembly 108 includes LEDs, LDs, or a combination of LEDs and LDs.

Further, the illuminating devices 110 are typically selected for providing a plurality of different output wavelengths of electromagnetic radiation where the majority of the output is in the visible light region. In addition, one or more of the illuminating devices 110 may provide output wavelengths in the infrared region of the electromagnetic spectrum in addition to output wavelengths in the visible light spectrum. Reflective faces may be included in each of the illumination assemblies 108 for controlling the strength of the output and/or directing the output towards a specific target that is external to the illumination assembly 108.

The output of each illumination assembly 108 directed at the optical code is returned to the optical code reader 260 as a reflected light signal that is impinged on the image sensor 106. Proper alignment of the optical code reader 260 and the optical code results in receiving a reflected light signal having a maximum intensity, thereby minimizing misreads and no-reads of the optical code or indicia.

The aiming or targeting assembly 109 located beneath the illumination assembly 108 provides for proper alignment. The targeting assembly includes one or more illuminating devices 111 for propagating a beam spot or other pattern towards the optical code during an imaging operation. The illuminating device 111 may be an LED, a laser, or other type of illuminating device known in the art.

For illumination assemblies 108, which include a plurality of illuminating devices 110, the output of the illuminating devices 110 may include different wavelengths in the visible and/or invisible light range. If all of the outputs are in visible light range, typically the respective output wavelengths of the illuminating devices 110 are in discrete ranges to provide a combined output where an observer could discern the different wavelengths which correspond to different colors of visible light. It is contemplated that when the combined output of all the illuminating devices 110 includes different wavelengths of light representing different discernable colors of light, the combined output of each illumination assembly 108 may be constant by having each illuminating device 110 emitting its particular output simultaneously.

If more than one illuminating device 1 10 is disposed in each illumination assembly 108, it is envisioned that each illuminating device 110 may be turned on and off independently of the other illuminating devices 110 thereby producing a random or fixed output pattern of emitted light. This random or fixed output pattern of emitted light may include infrared light as well as light within the visible light range of the electromagnetic spectrum. Further still, it is contemplated that the activation of each illumination assembly 108 may be controlled by a microprocessor in the imaging engine 100 or by the circuitry 212 in the optical code reader 260, either manually, e.g. upon depression of the trigger, or automatically.

In the imaging engine 100 where a plurality of illumination assemblies 108 is included, it is preferred that the illumination assemblies 108 are positioned about the image sensor 106 to provide optimal illumination of the target.

Additionally, the outputs of each illumination assembly 108 may be selected to illuminate a remote target that is external to the optical reader, provide an output for a focusing means, and/or provide an output for a range determining means. An example of a range determining means is disclosed in U.S. Pat. No. 6,123,264 to Li et al., the contents thereof are hereby incorporated by reference. Examples of auto-focusing means for handheld optical code readers are disclosed in U.S. Pat. Nos. 5,796,089 and 5,920,060 to Marom, the contents thereof are hereby incorporated by reference.

Illuminating the remote target preferably includes producing a targeting beam of visible light and/or infrared radiation that is usable in aligning the image sensor 106 with the optical beam path of the optical code reader 260. When the output is visible light, reflection from the optical code indicates to an operator that the image sensor 106 is correctly aligned. If infrared radiation is used for the targeting beam, visual and/or audible indications on the optical code reader 260 inform the operator that the image sensor 106 is properly aligned.

Preferably, the visible light or infrared radiation targeting beam cooperates with the circuitry 212 in the optical code reader 260 and automatically determines when the imaging sensor 106 is aligned. After the alignment is determined by the operator or the optical code reader 260, the imaging engine 100 is ready to generate an output for reading the optical code or indicia.

Advantageously, each illumination assembly 108 includes a substantially transparent optical window 114 that permits substantially all the generated output of each illuminating device 110 to be directed towards the optical target of the code reader. If the imaging engine 100 includes more than one illumination assembly 108, the optical window 114 may be of unitary construction that is configured and adapted to be disposed adjacent to each illumination assembly 108, and in particular completely covering the output port of each illumination assembly 108.

When the optical window 114 is unitarily formed, it defines a void that aligns with the image sensor 106. By locating the void in alignment with the image sensor 106, the optical window 114 will not adversely affect the light impinging on the image sensor 106 and therefore, will not degrade the received signal data. In lieu of a unitarily formed optical window 114, a plurality of optical windows 114 may be disposed on the face of the base member 102 with each optical window configured and adapted to only cover a matching illumination assembly 108. By using multiple optical windows 114 that only cover the illumination assemblies 108, the image sensor 106 will remain uncovered thereby allowing reflected light to impinge upon the image sensor 106 without any degradation resulting from an interceding optical component. Conventional means are used to attach the optical window 114 to the base member 102 of the substrate 120.

Typically, the optical window 114 is formed from a suitable and substantially transparent optical quality glass. Typically, the selected optical quality glass will have low value of reflectance, a low value of absorptance, and a high value of transmittance. Further still, the glass may be selected to have specific optical properties such as different transmittance values for different wavelengths of light thereby allowing the illuminating devices 110 to be matched with the optical window 114 for maximum transmittance of the emitted wavelength. It is also envisioned that optical grade plastic may be substituted for glass. In one embodiment, the optical window 114 is positioned substantially adjacent to the illuminating devices 110 to maximize the quantity of transmitted output and therefore minimize the amount of reflected light that can cause “flashover.”

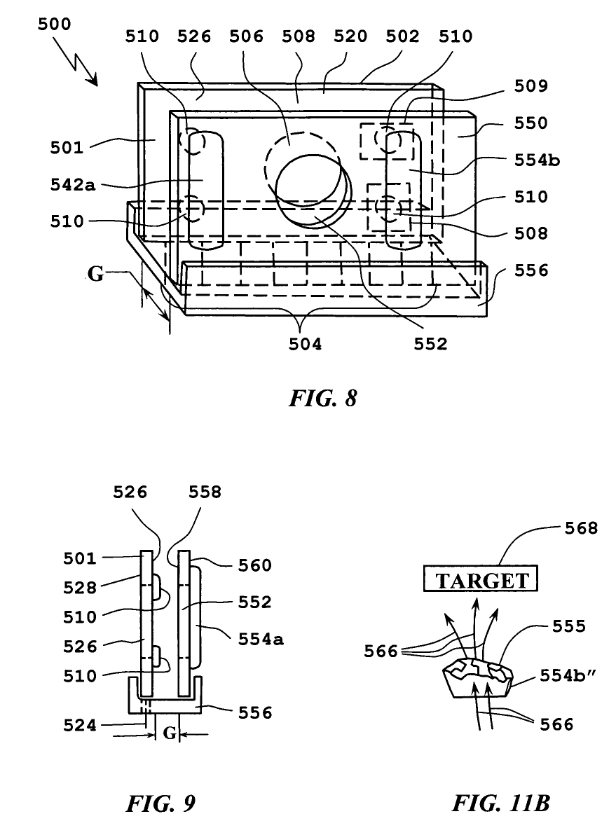

In a conventional imaging engine, there exists a gap between the output of an illuminating device and an optical window, thereby causing a part of the generated output to be reflected away from the target and generally towards the source of the output as seen in FIG. 8. Internal reflections off the optical window result in a loss of transmitted light to the target, thereby reducing the amount of light that is received by the image sensor from the target. These internal reflections also create raised levels of ambient light within the optical code reader that may interfere with distinguishing the light reflected from the target and the ambient light within the optical code reader. Overcoming these drawbacks require increasing the output of the illuminating devices and/or changing the surface materials/colors of the optical code reader to reduce the ambient light. Further still, these drawbacks result in increasing the number of misreads and no-reads of the optical code reader.

By minimizing the amount of light reflected from a spaced-apart optical window, the embodiments of the present disclosure permit a higher percentage of the generated output to reach the intended target. This increases the range of the optical code reader, reduces power consumption of the optical code reader, increases accuracy and repeatability of the optical code reader, and substantially reduces the number of misreads and no-reads.

Data transfer and communications between the imaging engine 100 and the optical code reader is accomplished via the signal interface system 104. In one form, the signal interface system 104 includes a number of electrically conductive elements that are accessible on at least one external location of the imaging engine 100 and therefore, are in communication with a comparably configured receptacle in the optical code reader 260 for signal data communication. Another method for interfacing the imaging engine 100 and the optical code reader 260 includes the signal interface system 104 having at least one optically conductive element 128 for exchanging data between the imaging engine 100 and the optical code reader 260 as shown in FIG. 5.

It is further contemplated that the interface between the imaging engine 100 and the optical code reader 260 may employ a wireless signal interface system for the data transfer. In a wireless configuration, signal interface system 104 includes a wireless transceiver in the imaging engine 100 and a corresponding wireless transceiver in the optical code reader 260.

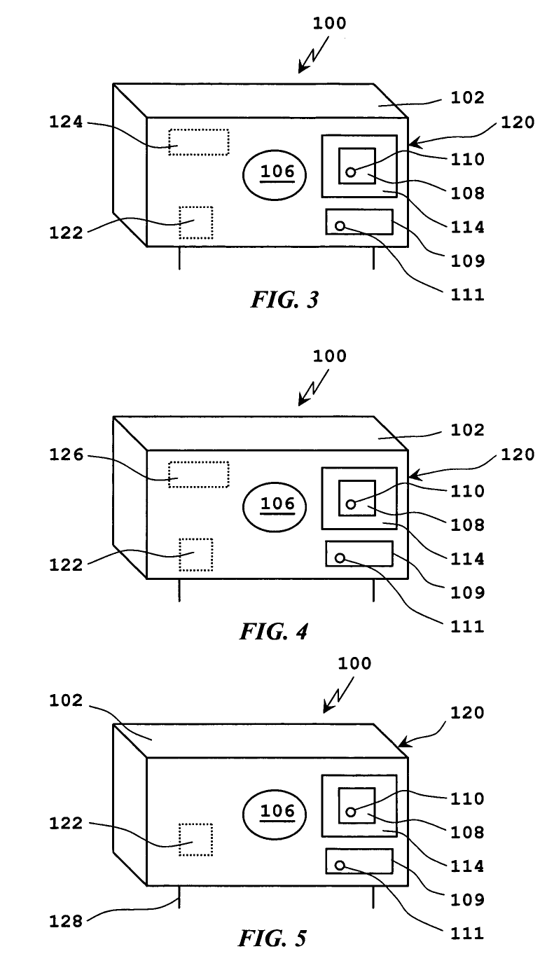

Referring to FIGS. 3 and 4, examples of wireless communications are illustrated. In the embodiment shown in FIG.3, the imaging engine 100 includes an infrared assembly 124 that generates an infrared output. The infrared assembly 124 further includes an infrared receiver for receiving reflected infrared signals. Information contained in the reflected infrared signals is processed by the infrared assembly 124 and is transferred to the optical code reader 260 through the interface assembly 122. Data from the optical code reader 260 is transferred to the imaging engine 100 via the interface assembly 122. For maximum flexibility and compatibility, infrared communications and data transfers typically follow protocols established by the Infrared Data Association (IRDA).

An alternate wireless communication means is shown in FIG. 4 wherein the imaging engine 100 includes a radio-frequency assembly 126. Radio-frequency transmission and reception mechanisms are included in the radio-frequency assembly 126 along with other signal processing systems. Radio-frequency assembly 126 transmits and receives information in the form of radio waves. Information processed by the radio-frequency assembly 126 is transferred to the optical code reader 260 through the interface assembly 122.

In an alternate embodiment of the imaging engine 100, the base member 102 is a semiconductor formed from one or more semiconductor materials that are known in the art. As discussed previously, the base member 102 includes at least one image sensor 106 and at least one illumination assembly 108. Each illumination assembly 108 further includes at least one illuminating device 110 wherein each illuminating device 110 is either an LED or a semiconductor laser. Typically, the semiconductor laser is a LD such as the VCSEL type.

Since the base member 102 is a semiconductor, each imaging engine 100, including the image sensors 106 and the illumination assemblies 108, can be manufactured as a discrete component that is packaged in a non-conductive casing having at least one signal interface system 104 that interconnects the imaging engine 100 with the optical code reader 260.

Each illumination assembly 108 generates a number of outputs that are determined by the number of illuminating devices 110 included in each illumination assembly 108. One or more of the outputs may be in the infrared range for illumination of the target, supplying an output for a range determining means, supplying an output for an auto-focusing means, or supplying an output for transferring signal data to the optical code reader 260. Alternately, the illumination assembly 108 may produce one or more outputs in the visible light range as discussed in the previous embodiment. However, the LEDs and/or LDs of the previous embodiment were discrete components disposed in the base member 102. In this embodiment, the LEDs and LDs are formed in the semiconductor base member 102 wherein their outputs are directed towards one or more faces of the imaging engine 100 depending on their function.

By way of example only, an illumination assembly 108 may include an infrared LED, a red LED, and a red LD formed as integral components of the semiconductor base member 102. In this example, the output of the infrared LED may be oriented to transmit data signals to a corresponding infrared receiver in the optical code reader 260, while the red LED may be positioned so that its output is directed in a different direction for illuminating a remote target and the red LD is oriented in the same direction as the red LED.

Although it may seem redundant to have both the red LED and the red LD outputs oriented in the same direction, operational considerations may require the use of the red LED in certain circumstances while the red LD may be employed under different conditions for the same optical code reader. The output of each illumination assembly 108 that is directed at the optical code is returned to the optical code reader 260 as the reflected light signal that impinges on the image sensor 106. Proper alignment of the optical code reader 260 and the optical code results in a reflected light signal with its maximum intensity thereby minimizing misreads and no-reads of the optical code.

Interconnections among the image sensor 106, the illumination assembly 108, and signal interface system 104 for transferring signal data are incorporated into the semiconductor base member 102 during manufacturing and are therefore integral to the imaging engine 100. As in the previous embodiment, the interconnections permit signals to be transferred between the image sensor 106 and the optical code reader 260 via the signal interface system 104 and between the illuminating devices 110 that are included in the illumination assembly 108 and the optical code reader 260 through the signal interface system 104.

Data transfer and communications between the imaging engine 100 and the optical code reader 260 is accomplished via the signal interface system 104. In one configuration, signal interface system 104 includes a number of electrically conductive elements that are accessible on at least one external location of the imaging engine 100 and therefore are in communication with a comparably configured receptacle in the optical code reader 260 for signal data communication. Additionally, the conductive elements of the signal interface system 104 releasably attach the imaging engine 100 to the receptacle in the optical code reader 260.

Another method for interfacing the imaging engine 100 and the optical code reader 260 includes providing signal interface system 104 operatively coupled with at least one optical interface system for exchanging data between the imaging engine 100 and the optical code reader 260. It is further contemplated that the interface between the imaging engine 100 and the optical code reader 260 may employ a wireless signal interface system 104 for the data transfer. In a wireless configuration, signal interface system 104 includes a wireless transceiver in the imaging engine 100 and a corresponding wireless transceiver in the optical code reader 260. Examples of wireless communication media include radio-frequency communications and infrared communications. Conventional methods for releasably attaching the imaging engine 100 to the optical code reader 260 are envisioned when the signal interface system 104 includes optically conductive elements or a wireless arrangement.

Advantageously, each illumination assembly 108 includes a substantially transparent optical window 114 that permits substantially all the generated output of each illuminating device 110 to be directed towards the optical target of the code reader. If the imaging engine 100 includes more than one illumination assembly 108, the optical window 114 may be of unitary construction that is configured and adapted to be disposed adjacent to each illumination assembly 108, and in particular completely covering the output port of each said illumination assembly 108. When the optical window 114 is unitarily formed, it defines a void that aligns with the image sensor 106. By locating the void in alignment with the image sensor 106, the optical window 114 will not adversely affect the light impinging on the image sensor 106 and therefore will not degrade the received signal data.

In lieu of a unitarily formed optical window 114, a plurality of optical windows 114 may be disposed on the face of the base member 102 with each optical window configured and adapted to only cover a matching illumination assembly 108. By using multiple optical windows 114 that only cover the illumination assemblies 108, the image sensor 106 will remain uncovered, thereby allowing reflected light to impinge upon the image sensor 106 without any degradation resulting from an interceding optical component. Conventional means are used to attach the optical window 114 to the base member 102 of the substrate 120.

Typically, the optical window 114 is formed from a suitable and substantially transparent optical quality glass. Typically, the selected optical quality glass will have low value of reflectance, a low value of absorptance, and a high value of transmittance. Further still, the glass may be selected to have specific optical properties, such as different transmittance values for different wavelengths of light, thereby allowing the illuminating devices 110 to be matched with the optical window 114 for maximum transmittance of the emitted wavelength. It is also envisioned that optical grade plastic may be substituted for glass. In the preferred embodiment, the optical window 114 is positioned substantially adjacent to the illuminating devices 110 to maximize the quantity of transmitted output, and therefore minimize the amount of reflected light.

In a conventional imaging engine 408, there exists a gap between the output of an illuminating device 410 and an optical window 414, thereby causing a part of the generated output to be reflected away from the target and generally towards the source of the output, as shown by arrows “A1” and “A2” in FIG. 8. Internal reflections off of the optical window 414 result in a loss of transmitted light to the target, thereby reducing the amount of light that is received by the image sensor from the target and also create raised levels of ambient light within the optical code reader that may interfere with distinguishing the light reflected from the target and the ambient light within the optical code reader. Overcoming these drawbacks requireS increasing the output of the illuminating devices 410 and/or changing the surface materials/colors of the optical code reader to reduce the ambient light. Further still, these drawbacks result in increasing the number of misreads and no-reads of the optical code reader.

By minimizing the amount of light reflected from a spaced apart optical window, the embodiments of the present disclosure permit a higher percentage of the generated output to reach the intended target. This increases the efficiency of the imaging engine which provides an increased range of the optical code reader, reduced power consumption of the optical code reader, and/or increased accuracy and repeatability of the optical code reader due to minimizing the number of misreads and no-reads of the optical code reader.

A method of using either embodiment of the imaging engine 100 is hereinafter disclosed.

Maximum flexibility is achieved since either embodiment is configurable and adaptable for use in both mobile and stationary optical code readers. Reading a remote target indicium using the imaging engine 100 of the present disclosure includes the following steps. An operator using the optical code reader 260 which includes the imaging engine 100 aims the optical code reader 260 at the desired remote optical target such as a barcode located on an object. Aiming the optical code reader 260 may include actuating a targeting beam of light (including infrared radiation).

The targeting beam of light is generated and propagated by the targeting assembly 109. The targeting beam of light, in conjunction with the circuitry 212 in the optical code reader 260, indicates to the operator that the image sensor 106 is properly aligned with the optical beam path of the optical code reader 260. Once aligned, the image sensor 106 receives the maximum quantity of the reflected light signal from the targeted optical code. An indication that the image sensor 106 is properly aligned includes visual observation of the targeting beam of light on the optical code.

In addition, the optical code reader 260 may generate visual and/or audible indications when using visible light or infrared radiation as the targeting beam. By properly aligning the image sensor 106 with the reflected light signal in this manner, the imaging engine 100 minimizes the number of misreads and no-reads of the optical code. Once the image sensor 106 is properly aligned, the operator initiates the acquiring finction of the optical code reader 260. Typically, the targeting beam cooperates with the circuitry 212 in the optical code reader 260 to determine when the image sensor 106 is properly aligned and automatically initiates the acquiring function of the optical code reader 260.

Acquiring the optical code includes actuating the illumination assembly 108 to illuminate the optical code by generating at least one output by the one or more illuminating devices 110. Each output is preferably in the visible light range corresponding to a particular color of discemable light or in the infrared region of the electromagnetic spectrum. The output can be determined by the optical code to be read and the design of the image sensor 106 that is included in the imaging engine 100. Since the image sensor 106 is aligned to receive the reflected light signal, the image sensor 106 receives the maximum impingement of the reflected light signal. The image sensor 106 processes the reflected light signal and converts the data contained within the reflected light signal into a data signal that is transferred to the circuitry 212 within the optical code reader 260.

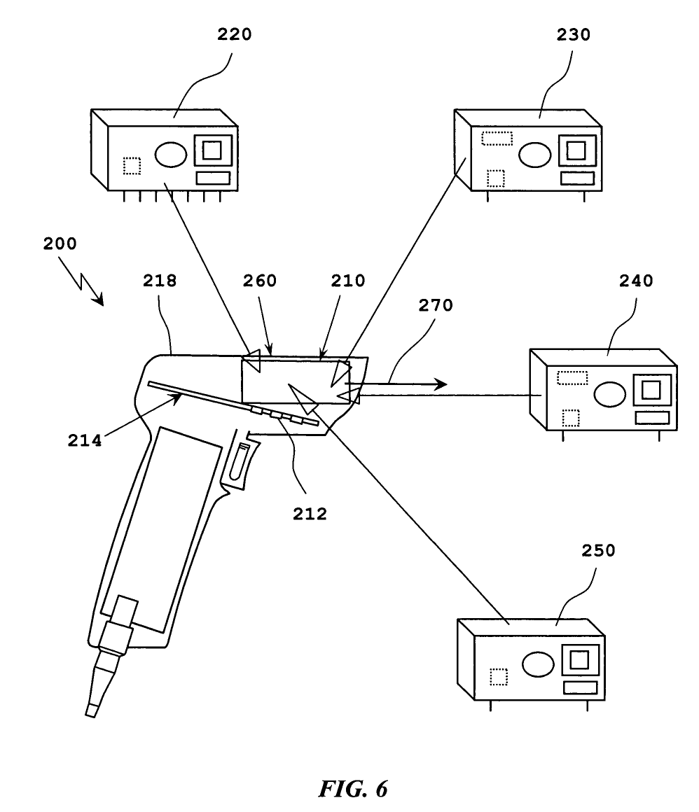

An imaging system 300 according to one embodiment of the present disclosure is hereinafter disclosed with reference to the block diagram of FIG. 6. The imaging system 300 includes an imaging engine 302 and an illumination assembly 304. Furthermore, the imaging system 300 is configured and dimensioned to fit within a predetermined form factor, such as the SE900 form factor. The imaging engine 302 may be one of the types already known in the art or it may be one of the types previously disclosed in the instant application. In addition, the illumination assembly 304 of the imaging system 300 may be integral with the imaging engine 302 as previously disclosed, or typically is a separate component that is configured and adapted to cooperate with the selected imaging engine 302. When the illumination assembly 304 is a separate component it may be placed inside the optical code reader 260 or externally attached to the optical code reader 260. In both of the above-mentioned configurations, the illumination assembly 304 interfaces with the circuitry 212 of the optical code reader 260 and/or the imaging system 300.

Typically, the imaging system 300 is controlled by a microprocessor 308. The microprocessor 308 is included in the imaging system 300, as shown in FIG. 6, or may be external to the imaging system 300. The microprocessor 308 has communication data paths between (1) itself and the illumination assembly 304, (2) itself and the circuitry 212 in the optical code reader 260, and (3) itself and the imaging engine 302. Typically, the microprocessor 308 controls the illumination assembly 304 and the imaging engine 302.

Each illumination assembly 304 includes at least one illuminating device 306. Each illuminating device 306 is selected from the group consisting of LEDs, lasers, incandescent illuminating elements, and gas-filled tubes. LEDs and incandescent illuminating elements are known in the art, while lasers include semiconductor edge-emitting injection lasers or VCSELs. Illuminating elements 306 of the gas-filled tube type include those filled with a gas, such as xenon, that is typically used in electronic flash devices.

In the imaging system 300 of the present disclosure, the illumination assembly 304 may disposed adjacent to the imaging engine 302 or may be disposed in another location of the optical code reader 260. These alternate locations for the illumination assembly 304 include the interior and the exterior of the optical code reader 260 with each location providing an interface between the illumination assembly 304 and the microprocessor for transferring signal data. Regardless of its location relative to the imaging engine 302, the illumination assembly 304 is disposed so that its output illuminates a selected target and the light reflected from the target is received by the optical code reader 260 and, more particularly, the imaging engine 302 of the optical code reader 260. Additionally, the optical code reader 260 may include a means for auto-focusing and/or a means for determining the distance between the optical code reader 260 and a target. In these instances, the output from the illumination assembly 304 may be used to supply some or all of the incident light used in conjunction with a distance determining means and/or an auto-focusing means.

Alternately, the illumination assembly 304 includes a plurality of illuminating devices 306 whose output is substantially in the visible light range. In this configuration, the illumination assembly 304 has an output that includes several different wavelengths in the visible light range. If all of the outputs are in visible light range, the respective output wavelengths of the illuminating devices 306 may be in discrete ranges to provide a combined output where an observer is able to distinguish between the different wavelengths that correspond to different colors of visible light.

When the total output of all the illuminating devices 306 includes different wavelengths of light representing different discernable colors of light, the total output of each illumination assembly 304 may be constant in that each illuminating device 306 emits its particular output simultaneously. If more than one illuminating device 306 is disposed in each illumination assembly 304, it is envisioned that each illuminating device 306 may be turned on and off independently of the other illuminating devices 306, thereby producing a random or repeating output pattern of emitted light. This random or repeating output pattern of emitted light may include infrared light as well as light within the visible light range of the electromagnetic spectrum.

A method of using the imaging system 300 is hereinafter disclosed. Maximum flexibility is achieved since the imaging system 300 is configurable and adaptable for use in both mobile and stationary optical code readers. Reading a remote target indicium using the imaging system 300 of the present disclosure includes the following steps. An operator using an optical code reader, such as the optical code reader 260, that includes the imaging system 300 aims the optical code reader at the desired remote optical target such as a barcode located on an object. Aiming the optical code reader may include actuating a targeting beam of light (including infrared radiation) using an aiming and targeting assembly, such as aiming and targeting assembly 109, that, in conjunction with circuitry in the optical code reader, such as circuitry 212, indicates to the operator that the imaging engine 302 is aligned with the optical beam path of the optical code reader and therefore, is aligned to receive the maximum quantity of the reflected light signal from the target optical code. Indication that the imaging engine 302 is correctly aligned includes visual observation of the targeting beam on the optical code. In addition, the optical code reader may generate visual and/or audible indications when using visible light or infrared radiation as the targeting beam. By properly aligning the imaging engine 302 with the reflected light signal in this manner, the illumination assembly 300 minimizes the number of misreads and no-reads of the optical code.

After the imaging engine 302 is properly aligned, the operator initiates the acquiring function of the optical code reader. Typically, the targeting beam cooperates with the circuitry in the optical code reader to determine when the imaging engine 302 is properly aligned and automatically initiates the acquiring function of the optical code reader.

Acquiring the optical code includes actuating the illumination assembly 304 to illuminate the optical code by generating at least one output. Each output may be a range of wavelengths in the visible light range corresponding to a particular color of discemable light or may be in the infrared region of the electromagnetic spectrum. The output that is selected is determined by the optical code to be read and the design of the imaging engine 302 that is included in the imaging system 300. Since the imaging engine 302 is still aligned to receive the reflected light signal, the imaging engine 302 receives the maximum impingement of the reflected light signal. The imaging engine 302 processes the reflected light signal and converts the data contained in the reflected light signal into a data signal that is transferred to the circuitry in the optical code reader.

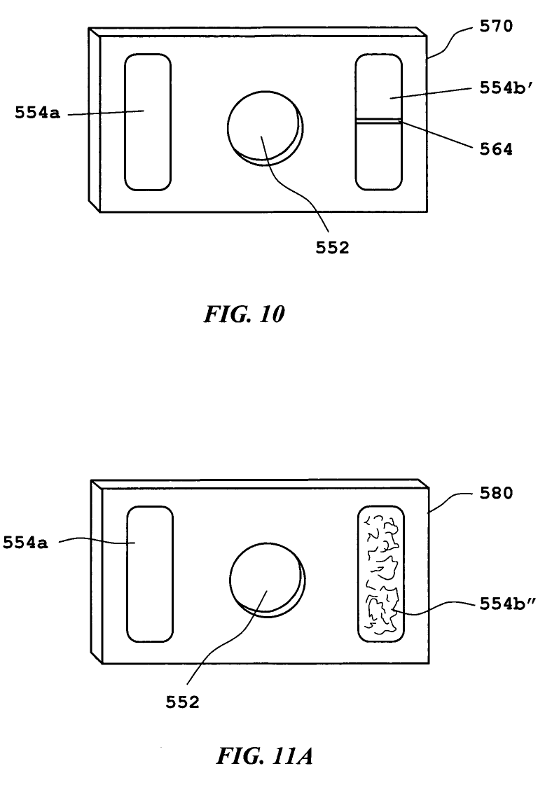

FIGS. 9-10 disclose an integrated exit window lens array and imaging engine 500 according to one embodiment of the present disclosure. More particularly, referring to FIG. 9, the integrated exit window lens array and imaging engine 500 includes an imaging engine 501 which is configured and dimensioned to fit within a predetermined form factor of the optical code reader 260 having a housing 218 and circuitry 212 therein (See FIG. 7). The imaging engine 501 includes at least one image sensor 506 provided on a substrate 520. The substrate 520 has an outer surface 526 and an inner surface 528. The imaging engine 501 also includes at least one illumination assembly 508 having at least one illuminating device 510. The at least one illuminating device 508 is also provided on substrate 520.

The imaging engine 501 includes an interface 522 having at least one signal path 524 which is configured for providing at least one control signal to the at least one imaging sensor 506. The at least one control signal is generated and transmitted to the interface 522 of the imaging engine 501 by the circuitry 212 housed within the housing 218 for operating the at least one image sensor 506 and the at least one illumination assembly 508.

The integrated exit window lens array and imaging engine 501 also includes a substantially flat, at least partially transmissive, planar exit window lens array 550 having at least one orifice 552 therein. The exit window lens array 550 includes an outer surface 560 distal to a user and an inner surface 558 proximal to a user of the optical code reader 260. The exit window lens array 550 further includes at least one and typically at least two transmissive optic surfaces 554a and 554b disposed thereupon, such as on the outer surface 560, and an integrating member 556 for integrating the exit window lens array 550 with the substrate 520.

The exit window lens array 550 is configured for substantially aligning the at least one orifice 552 with the at least one image sensor 506 when the exit window lens array 550 is integrated by the integrating member 556 with the substrate 520 such that the inner surface 558 of exit window lens array 550 at least partially opposes outer surface 526 of substrate 520 of imaging engine 501. In particular, the at least one orifice 552 is aligned with the optical path of the at least one image sensor 506. The substrate 520 lies substantially in a plane which is substantially parallel to the plane in which the exit window lens array 550 lies.

In addition, the exit window lens array 550 may be configured for substantially aligning the at least one illuminating device 510 with the at least one transmissive optic surface 554a, 554b when the exit window lens array 550 is integrated with the substrate 520 such that the inner surface 558 of the exit window lens array 550 at least partially opposes outer surface 526 of substrate 520..

In one embodiment, the mounting member 556 is configured to provide a gap “G” between the outer surface 526 of the substrate 520 and the inner surface 558 of the exit window lens array 550. The at least two optic surfaces 554a and 554b are disposed on the outer surface 560 of the exit window lens array 550 and are at least partially transmissive for enabling illumination generated by the at least one illuminating device 510 to transmit therethrough.

The exit window lens array 550 may also have optical power and or optical properties and can be used to modify the illumination pattern such as by, for example and not limited to, polarization, light dispersion and other optical effects and methods.

For example, FIG. 11 discloses an alternate embodiment of an exit window lens array according to the present disclosure, i.e., exit window lens array 570 includes at least one transmissive optic surface and typically at least two transmissive optic surfaces 554a and 554b′. More particularly, optic surface 554b′may include a slot 564 for dispersing light generated by the at least one of the at least two LEDs 510, while the other one of the at least two optic surfaces 554a may be substantially uniform to enable illuminating a target object (not shown). The at least two LEDs 510 may be configured to provide different colors of illumination such as red, green or blue.

In another embodiment of an exit window lens array according to the present disclosure, as illustrated in FIGS. 12A and 12B, exit window lens array 580 includes at least one transmissive optic surface and typically at least two optic surfaces 554a and 554b″. More particularly, optic surface 554b″may include a prismatic surface 555 for dispersion of the illumination 566 from the at least two LEDs 510 passing therethrough to illuminate a target 568. The embodiments are not limited in this context.

The integrating member 556 of the exit window lens arrays 550, 570 or 580 may be in the form of a weld, e.g., an ultrasonic weld, or a fusion between the imaging engine 501 and the exit window lens arrays 550, 570 or 580. In addition, the integrating member 556 may be an extension of the imaging engine 501, e.g., an extension of the substrate 520, where the extension has means for supporting the exit window lens array 550, 570 or 580.

As discussed previously with respect to FIG. 7, depending upon the given application for the optical code reader 260, the installed imaging engine 501 is selected from among various plug-and-play imaging engines 220, 230, 240 or 250, wherein each imaging engine is designed and adapted for reading optical targets under different conditions of lighting, distance, type of optical target, or other given optical criteria. In one embodiment, the integrated exit window lens array and imaging engine 500 may be configured as a plug-and-play imaging engine in the same manner as imaging engines 220, 230, 240 or 250. The plug-and-play imaging engine can be mounted to an optical code reader which does not have an exit window lens array.

The integrated exit window lens array and imaging engine 500 may embody other features of imaging engines 220, 230, 240 or 250. More particularly, the at least one signal path 524 may transfer the at least one control signal between the at least one image sensor 506 and circuitry 212 of the optical code reader 260. The at least one signal path 524 may be selected from the group consisting of an electrical, an optical, and a wireless path, although other signal paths may be adapted. The imaging engine 501 may be an integrated circuit (IC) package where all the components are placed on the base member 502 and integrally formed as an integrated circuit package. The substrate 520 may be a semiconductor or be configured as a printed circuit board (PCB).

The at least one image sensor 506 may be configured for being positioned in an optical beam path 270 of the optical code reader 206. The at least one illuminating device 510 may include the at least two light-emitting diodes (LEDs) providing at least two different output wavelengths. In addition, the at least one illuminating device 510 may be selected from the group consisting of an LED, a semiconductor laser, and a flash module.

The substrate 520 may include depressions (not shown) for placement of the at least one image sensor 506 and the at least two LEDs 510 therein. The at least one image sensor 506 and at least two LEDs 510 are placed in such a manner that the at least one image sensor 506 and the at least two LEDs 510 are substantially flush with the outer surface 526 of the substrate 520, and in electrical communication with the at least one signal path 524. The imaging engine 501 may further include a targeting assembly 509 disposed on the outer surface 526 of the substrate 520, wherein the at least one signal path 524 provides at least one control signal to the targeting assembly 509.

In one embodiment, the present disclosure relates to the optical code reader 260 having the housing 218 and circuitry 212 therein, with the optical code reader 260 further including the integrated exit window lens array and imaging engine 500 configured and dimensioned to fit within a predetermined form factor of the optical code reader 260. The integrated exit window lens array and imaging engine 500 may be configured to include all of the features previously described, such as, for example but not limited to, being a plug-and-play imaging engine.

In one embodiment, the present disclosure relates to an improved imaging engine 501 of the type which includes at least one substrate 520; at least one light emitting diode (as represented by at least one illuminating device 510); and at least one image sensor 506 disposed upon the at least one substrate 520. The improved imaging engine 501 is characterized by an exit window lens array 550, 570 or 580 having at least one orifice 552 and at least two optic surfaces 554a, 554b, 554b′or 554b″; and integrating member 556. The exit window lens array 550 is configured to substantially align the at least one orifice 552 with the at least one image sensor 506 and the at least two light emitting diodes 510 to aim and target illumination generated by the at least one light emitting diode 510 when the exit window lens array 550, 570 or 580 is integrated by integrating member 556 with the substrate 520. In one embodiment, the integrated exit window lens array imaging engine 500 configured with at least two light emitting diodes 510 may be configured to include all of the features previously described, such as, for example but not limited to, being a plug-and-play imaging engine.

Based on the foregoing disclosure, it can be appreciated that the exit window lens array described herein facilitates the design of the imaging engine 501 by reducing or eliminating the internal reflections caused by illumination generated by the illumination devices.

Furthermore, those of ordinary skill in the art will recognize that the exit window lens array 550, 570, or 580 may be integrated also, via integrating member 556, with any of the previously described imaging engines 220, 230, 240 or 250.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. An integrated exit window lens array and imaging engine, the integrated exit window lens array and imaging engine comprising:
an imaging engine configured and dimensioned to fit within a predetermined form factor of an optical code reader having a housing and circuitry therein, said imaging engine including:
at least one image sensor;
at least one illumination assembly having at least one illuminating device, the at least one image sensor and the at least one illuminating device being provided on a substrate;
an interface having at least one signal path configured for providing at least one control signal to the at least one image sensor,
wherein the at least one control signal is generated and transmitted to the interface of said imaging engine by said circuitry housed within said housing for operating said at least one image sensor and said at least one illumination assembly;
an exit window lens array having at least one orifice and at least one transmissive optic surface disposed thereupon; and
an integrating member for integrating the exit window lens array with the substrate, wherein the exit window lens array is configured for substantially aligning the at least one orifice with the at least one image sensor when the exit window lens array is integrated with the substrate such that an inner surface of the exit window lens array at least partially opposes an outer surface of the substrate.

2. The imaging engine of claim 1, wherein the imaging engine is a plug-and-play imaging engine.

3. The integrated exit window lens array and imaging engine of claim 1, wherein the exit window lens array is configured for substantially aligning the at least one illuminating device with the at least one transmissive, optical surface when the exit window lens array is integrated with the substrate such that an inner surface of the exit window lens array at least partially opposes an outer surface of the substrate.

4. The integrated exit window lens array and imaging engine of claim 1, wherein the at least one optic surface includes a slot.

5. The integrated exit window lens array and imaging engine of claim 1, wherein the at least one optic surface includes a prismatic surface.

6. The integrated exit window lens array and imaging engine of claim 1, wherein said substrate is a semiconductor.

7. The integrated exit window lens array and imaging engine of claim 1, wherein the substrate includes depressions for placement of the at least one image sensor and the illumination assembly, such that the at least one image sensor and the illumination assembly are substantially flush with an outer surface of the substrate and in electrical communication with the at least one signal path.

8. The integrated exit window lens array and imaging engine of claim 1, wherein the integrating member is an extension of the imaging engine where the extension has means for supporting the exit window lens array.

9. An optical code reader having a housing and circuitry therein, the optical code reader comprising:
an integrated exit window lens array and imaging engine, the integrated exit window lens array and imaging engine including:
an imaging engine configured and dimensioned to fit within a predetermined form factor of the optical code reader, said imaging engine comprising:
at least one image sensor;
at least one illumination assembly having at least one illuminating device, the at least one image sensor and the at least one illuminating device being provided on a substrate;
an interface having at least one signal path configured for providing at least one control signal to the imaging assembly,
wherein the at least one control signal is generated and transmitted to the interface of said imaging engine by said circuitry housed within said housing for operating said at least one image sensor and said at least one illumination assembly;
an exit window lens array having at least one orifice and at least one transmissive optic surface disposed thereupon; and
an integrating member for integrating the exit window lens array with the substrate,
wherein the exit window lens array is configured for substantially aligning the at least one orifice with the at least one image sensor when the exit window lens array is integrated with the substrate such that an inner surface of the exit window lens array at least partially opposes an outer surface of the substrate.

10. The optical code reader of claim 9, wherein the imaging engine is a plug-and-play imaging engine.

11. The optical code reader of claim 9, wherein the exit window lens array is configured for substantially aligning the at least one illuminating device with the at least one transmissive, optical surface when the exit window lens array is integrated with the substrate such that an inner surface of the exit window lens array at least partially opposes an outer surface of the substrate.

12. The optical code reader of claim 9 , wherein the at least one optic surface includes a slot.

13. The optical code reader of claim 9, wherein the at least one optic surface includes a prismatic surface.

14. The optical code reader of claim 9, wherein the at least one signal path transfers the at least one control signal between the at least one image sensor and circuitry of the optical code reader.

15. The optical code reader of claim 14, wherein the at least one signal path is selected from the group consisting of an electrical, an optical, and a wireless path.

16. The optical code reader of claim 9, wherein said imaging engine is an integrated circuit package.

17. The optical code reader of claim 9, wherein the at least one image sensor is configured for being positioned in an optical beam path of the optical code reader.

18. The optical code reader of claim 9, wherein said substrate is a semiconductor.

19. The optical code reader of claim 9, wherein the at least one illuminating device includes at least two light-emitting diodes providing at least two different output wavelengths.

20. The optical code reader of claim 9, wherein the substrate includes depressions for placement of the at least one image sensor and the illumination assembly, such that the at least one image sensor and the illumination assembly are substantially flush with an outer surface of the substrate and in electrical communication with the at least one signal path.

21. The optical code reader of claim 9, wherein the at least one illuminating device is selected from the group consisting of an LED, a semiconductor laser, and a flash module.

22. The optical code reader of claim 9, further comprising a targeting assembly, wherein the at least one signal path provides at least one control signal to the targeting assembly.

23. The optical code reader of claim 9, wherein the integrating member is an extension of the imaging engine where the extension has means for supporting the exit window lens array.

24. A printed circuit board (PCB)-based imaging engine of the type comprising:
at least one substrate;
at least one light emitting diode and at least one image sensor disposed upon the at least one substrate,
an exit window lens array having at least one orifice and at least two optic surfaces disposed thereupon;
wherein the improvement is characterized by:
an integrating member for integrating the exit window lens array with the substrate,
wherein the exit window lens array is configured for substantially aligning the at least one orifice with the at least one image sensor when the exit window lens array is integrated with the substrate such that an inner surface of the exit window lens array at least partially opposes an outer surface of the substrate.

25. The PCB-based imaging engine of claim 24, wherein the imaging engine is a plug-and-play imaging engine.
